(19) United States
(12) Patent Application Publication
(10) Pub. No.: US 2008/0073568 A1
(43) Pub. Date: Mar. 27, 2008

(54) Radiation image reading apparatus and method of controlling the same

(75) Inventors: Atsushi Yamazaki, Odawara-shi (JP); Yasunori Ohta, Yokohama-shi (JP); Yasuhiko Goto, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/902,849

(22) Filed: Sep. 26, 2007

(30) Foreign Application Priority Data
Sep. 26, 2006 (JP) 2006-261337
Sep. 29, 2006 (JP) 2006-268933
Sep. 29, 2006 (JP) 2006-268962

(51) Int. Cl. G03B 11/00

(52) U.S. Cl. 250/482.1

(57) ABSTRACT

A reading apparatus includes a cassette loader, which is loaded with a radiation cassette storing a radiation conversion panel therein. The radiation cassette has at least one portion thereof that is exposed outside of the reading apparatus. The cassette loader includes a shield cover disposed at least between a radiation source and the exposed portion of the radiation cassette, for thereby shielding the radiation cassette from radiation produced by the radiation source. The shield cover can be stored on the reading apparatus.

### BACKGROUND OF THE INVENTION

1. Field of the Invention

The present invention relates to a radiation image reading apparatus for reading radiation image information from a radiation conversion panel, which includes radiation image information recorded therein, as well as a method for controlling a radiation image reading apparatus.

2. Description of the Related Art

When a certain type of phosphor is irradiated with radiation (X-rays, α-rays, β-rays, γ-rays, ultraviolet radiation, electron beams, or the like), a portion of the radiation energy is stored therein. Then, when the phosphor is subsequently exposed to an applied stimulating light, such as visible light, it emits stimulated light in proportion to the stored radiation energy.

An image capturing apparatus has been developed for temporarily recording radiation image information of a subject, such as a human body or the like, on a stimulable phosphor panel (radiation conversion panel) made of the above phosphor, together with a reading apparatus for scanning a stimulable phosphor panel, which has radiation image information recorded therein, with stimulating light, and photoelectrically reading the stimulated light emitted from the stimulable phosphor panel in order to generate an image signal, whereby the image signal is processed to produce an image for diagnosis.

The stimulable phosphor panel, from which radiation image information is read, can be reused when the stimulable phosphor panel is irradiated with erasing light, including light within a wavelength range of the stimulating light, so as to erase any residual radiation image information therefrom. Therefore, the reading apparatus frequently incorporates an erasing apparatus therein for erasing residual radiation image information from the stimulable phosphor panel by applying erasing light thereto.

When the image capturing apparatus captures additional radiation image information, while radiation image information recorded in a stimulable phosphor panel is being read by the reading apparatus, the radiation emitted from the radiation source within the image capturing apparatus possibly may enter into the reading apparatus and thereby adversely affect the radiation image information that is recorded within the stimulable phosphor panel.

Japanese Laid-Open Patent Publication No. 11-326600 discloses a radiation image reading apparatus designed to solve the above problem.

As shown in FIG. 13 of the accompanying drawings, the disclosed radiation image reading apparatus includes a housing 2 mounted on a base 1 and accommodating therein a panel assembly 3 positioned closely to a grid 4 set inside the housing 2. The panel assembly 3 comprises a pair of image capturing panels 3a, 3b and a radiation shield member 3c that is sandwiched between the image capturing panels 3a, 3b. The housing 2 has inner surfaces, except for the grid 4, which are covered with a radiation shielding layer 5.

First, radiation X emitted from a radiation source outside of the housing 2 is applied through the grid 4 to the image capturing panel 3a, which also faces the grid 4, in order to record radiation image information in the image capturing panel 3a. Then, the panel assembly 3 is reversed so as to bring another image capturing panel 3b into facing relation to the grid 4. Radiation X is applied through the grid 4 to the image capturing panel 3b, to record successive radiation image information in the image capturing panel 3b. While the next radiation image information is being recorded in the image capturing panel 3b, the radiation image information recorded in the image capturing panel 3a placed in the housing 2 is read. At this time, since the image capturing panel 3a is surrounded by the radiation shield member 3c as well as the radiation shielding layer 5 of the housing 2, the image capturing panel 3a is not adversely affected by radiation X from the external radiation source. Accordingly, the radiation image information recorded in the image capturing panel 3a can be read properly, while successive radiation image information is being recorded in the image capturing panel 3b.

The stimulable phosphor panel is often handled while being accommodated within a radiation cassette, so that different stimulable phosphor panel sizes can easily be selected depending on the region to be imaged, and the purpose for which the radiation image is to be captured. Certain image capturing and reading apparatuses are designed such that they can be loaded with radiation cassettes accommodating stimulable phosphor panels therein. When a reading apparatus thus designed is loaded with a radiation cassette, an end of the radiation cassette, which has an opening for enabling the stimulable phosphor panel to be inserted into and taken out of the radiation cassette, is placed in the reading apparatus, while the radiation cassette has a portion thereof that remains exposed outside of the reading apparatus. The reading apparatus of this design is relatively small in size and allows the cassette to be loaded and unloaded efficiently.

However, since a portion of the radiation cassette is exposed outside of the reading apparatus, when radiation is applied in an image capturing apparatus near to the reading apparatus, such radiation may also be applied to the radiation cassette that is loaded in the reading apparatus. Thus, radiation may possibly be applied to the stimulable phosphor panel in the radiation cassette, or possibly may pass through the radiation cassette and be applied to another stimulable phosphor panel within the reading apparatus.

Therefore, while radiation image information is being read by the reading apparatus, it is necessary to prohibit radiation from being applied from the image radiation apparatus. As a result, the process of capturing radiation image information and the process of reading recorded radiation image information cannot be carried out efficiently.

There is also an image capturing and reading apparatus including an image capturing base which is irradiated with radiation through a subject to be imaged, a reader for reading radiation image information recorded in a stimulable phosphor panel, and an eraser for erasing residual radiation image information from the stimulable phosphor panel by applying erasing light to the stimulable phosphor panel. The image capturing base, the reader, and the eraser are connected to each other by means of a circulatory feed path. Radiation image information is acquired from the stimulable phosphor panel while the stimulable phosphor panel is fed in a circulating manner along the circulatory feed path, among the image capturing base, the reader, and the eraser.

The image capturing and reading apparatus also operates in a mode wherein a stimulable phosphor panel supplied from outside of the image capturing and reading apparatus, rather than a stimulable phosphor panel that is already stored within the apparatus, is mounted on the image capturing base in order to capture a radiation image therein. At this time, if the stimulable phosphor panel already stored within the apparatus has moved near the image capturing base, then the radiation applied to the newly mounted stimulable phosphor panel also may be applied to the stimulable phosphor panel positioned near the image capturing base.

According to a solution disclosed in Japanese Laid-Open Patent Publication No. 61-39038, when the stimulable phosphor panel is mounted on the image capturing base to capture a radiation image therein, a shutter is inserted between the stimulable phosphor panel that is already stored within the apparatus and the image capturing base, so as to prevent radiation from being applied to the stimulable phosphor panel already stored within the apparatus.

The disclosed solution is applicable only to a system in which the image capturing apparatus and the reading apparatus are integrally connected with each other. This solution does not serve to protect from radiation a stimulable phosphor panel that is supplied to another reading apparatus, which is independent of the image capturing apparatus. If the reading apparatus is independent of the image capturing apparatus, then the reading apparatus is usually spaced a sufficient distance from the image capturing apparatus, and no special countermeasures are incorporated therein for blocking radiation including scattered rays.

In recent years, portable image capturing apparatuses have been developed for use in medical facilities such as hospitals, etc., wherein the portable image capturing apparatus is movable into patients' rooms for capturing images of various patients who are unable to move to an image capturing room. For quickly reading and processing radiation image information of a patient, which has been recorded on a stimulable phosphor panel by such a portable image capturing apparatus, the portable image capturing apparatus should preferably be accompanied by a reading apparatus, which also is brought into the patient's room. Accordingly, it is important for the reading apparatus to incorporate countermeasures for blocking radiation, including scattered rays, because the reading apparatus typically is placed near to the portable image capturing apparatus.

Since a plurality of stimulable phosphor panels are used to capture images of patients, a plurality of stimulable phosphor panels also needs to be kept at hand in the patient's room.

For this reason, storage devices for stacking a plurality of stimulable phosphor panels therein and supplying them on demand have been developed.

For example, storage devices, such as disclosed in Japanese Laid-Open Patent Publication No. 3-287250 and Japanese Laid-Open Patent Publication No. 64-18137, operate to remove a plurality of stimulable phosphor panels from radiation cassettes, while stacking the removed stimulable phosphor panels therein. The disclosed storage devices are coupled integrally to an image capturing apparatus. The storage device disclosed in Japanese Laid-Open Patent Publication No. 64-18137 operates by stacking a plurality of stimulable phosphor panels in a magazine, automatically removing one of the stimulable phosphor panels from the magazine, placing the removed stimulable phosphor panel into a radiation cassette, and then supplying the radiation cassette to the image capturing apparatus.

Japanese Laid-Open Patent Publication No. 2004-287040 discloses a storage device for stacking a plurality of radiation cassettes having respective stimulable phosphor panels stored therein. One of the radiation cassettes is selected, which stores a stimulable phosphor panel of a type required to capture a radiation image, and the selected radiation cassette is supplied to the image capturing apparatus.

The storage devices disclosed in Japanese Laid-Open Patent Publication No. 3-287250 and Japanese Laid-Open Patent Publication No. 64-18137 are not integrally combined with a reading apparatus, for reading radiation image information that has been recorded in a stimulable phosphor panel by the image capturing apparatus. Therefore, after radiation image information has been recorded on the stimulable phosphor panels, it is still necessary to carry the stimulable phosphor panels to a location where the reading apparatus is installed, in order to read the recorded radiation image information. Therefore, a long period of time is needed before the desired radiation image information can be obtained. One solution would be to employ a portable reading apparatus for use in a patient's room. However, a space availability problem occurs if the image capturing apparatus, the storage device, and the reading apparatus are all placed in the patient's room.

The storage device disclosed in Japanese Laid-Open Patent Publication No. 2004-287040 is liable to be large in size, because a plurality of radiation cassettes, each storing respective stimulable phosphor panels, are stacked therein.

### SUMMARY OF THE INVENTION

It is a general object of the present invention to provide a radiation image reading apparatus having a simple structure for reading radiation image information, along with a method for controlling such a radiation image reading apparatus.

Another object of the present invention is to provide a radiation image reading apparatus, which is capable of stacking a plurality of radiation conversion panels without the need for increasing apparatus size, wherein the radiation image reading apparatus is capable of acquiring desired radiation image information quickly for diagnosis or the like. The present invention also concerns a method for controlling such a radiation image reading apparatus.

Still another object of the present invention is to provide a radiation image reading apparatus, which is capable of protecting from exposure to radiation a radiation conversion panel stored within a cassette that is loaded in the radiation image reading apparatus, together with a method for controlling such a radiation image reading apparatus.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a radiation image forming system incorporating a reading apparatus according to a first embodiment of the present invention;

FIG. 2 is a vertical cross-sectional view showing internal structural details of the reading apparatus according to the first embodiment;

FIG. 3 is a perspective view of an upper portion of the reading apparatus according to the first embodiment;

FIG. 4 is a block diagram of a control system for the radiation image forming system incorporating the reading apparatus according to the first embodiment;

FIG. 5 is a vertical cross-sectional view showing internal structural details of a reading apparatus according to a second embodiment of the present invention;

FIG. 6 is a perspective view of an upper portion of a reading apparatus according to a third embodiment of the present invention;

FIG. 7 is a block diagram of a radiation image forming system, incorporating a reading apparatus according to a fourth embodiment of the present invention;

FIG. 8 is a vertical cross-sectional view showing internal structural details of the reading apparatus according to the fourth embodiment;

FIG. 9 is a block diagram of a control system for the radiation image forming system incorporating the reading apparatus according to the fourth embodiment;

FIG. 10 is a vertical cross-sectional view showing internal structural details of a reading apparatus according to a fifth embodiment of the present invention;

FIG. 11 is a vertical cross-sectional view of the reading apparatus shown in FIG. 10, with a shutter inserted into a cassette;

FIG. 12 is a block diagram of a control system for the radiation image forming system incorporating the reading apparatus according to the fifth embodiment; and

FIG. 13 is a vertical cross-sectional view of a radiation image reading apparatus pertaining to the related art.

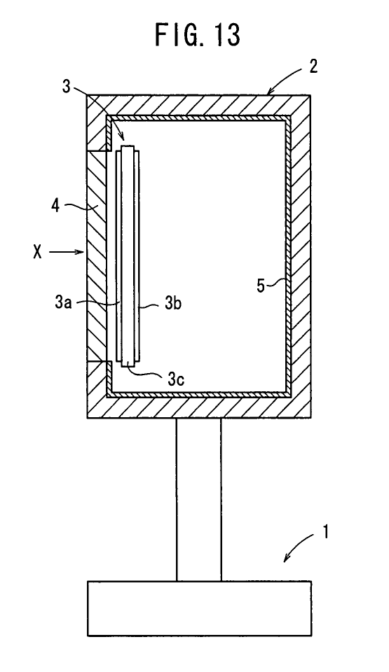

### DESCRIPTION OF THE PREFERRED EMBODIMENTS

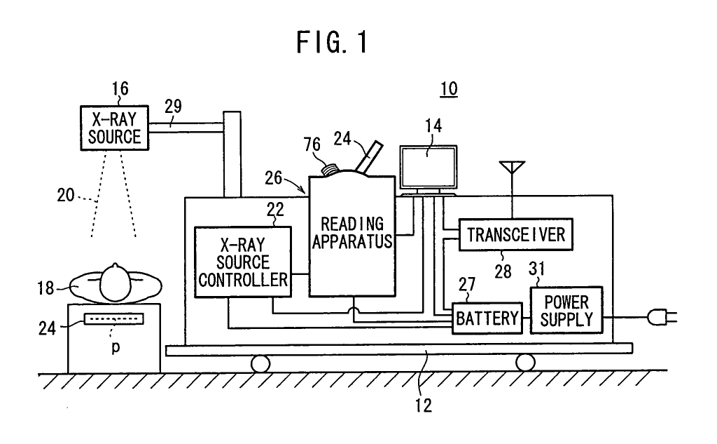

FIG. 1 shows in block form a radiation image forming system 10 incorporating a reading apparatus according to a first embodiment of the present invention. The radiation image forming system 10 is mounted on a carriage 12 for movement into a patient's room in a hospital or the like.

The radiation image forming system 10 includes a console 14 for entering or acquiring, from an external source, image capturing information for capturing radiation image information. The console 14 includes a display, and an X-ray source controller 22 for controlling an X-ray source 16 based on the image capturing information supplied from the console 14, so as to apply X-ray radiation 20 to a subject 18. The console 14 further includes a reading apparatus 26 capable of being loaded with a cassette (radiation cassette) 24 storing therein a stimulable phosphor panel (radiation conversion panel) P, which records radiation image information when irradiated with X-ray radiation 20 that has passed through the subject 18, and reads the radiation image information from the stimulable phosphor panel P. Additionally, the console 14 has a transceiver 28 for transmitting radiation image information read from the stimulable phosphor panel P to an external device, and receiving necessary information from the external device, and a battery 27 for supplying electric power to the console 14, the X-ray source 16, the X-ray source controller 22, the reading apparatus 26 and the transceiver 28.

The X-ray source 16 is connected to the X-ray source controller 22 through an arm 29. The battery 27 is connected to a battery charger 31 and is charged thereby.

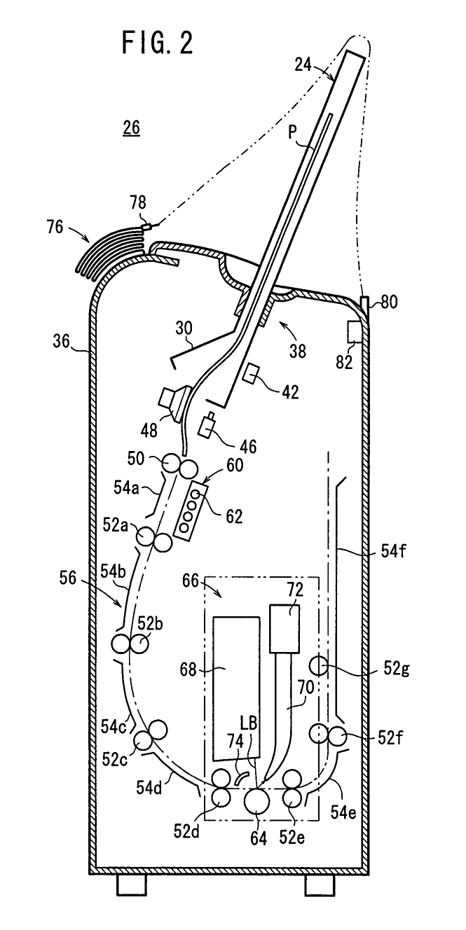

As shown in FIG. 2, the cassette 24 loaded in the reading apparatus 26 includes an openable and closable lid 30. A bar code, not shown, having recorded therein ID information for identifying the cassette 24, is applied to the cassette 24.

The reading apparatus 26 has a cassette loader 38 in an upper end of a casing 36. The cassette 24, which stores the stimulable phosphor panel P having radiation image information recorded therein, is loaded into the cassette loader 38 with the lid 30 thereof being positioned downward. The loaded cassette 24 has an upper portion exposed outside of the reading apparatus 26. The casing 36 preferably is made of a material containing a heavy metal, such as lead or the like, for preventing X-ray radiation 20 from entering into the casing 36.

The cassette loader 38 includes a bar-code reader 42 for reading the bar code on the cassette 24, an unlocking mechanism 46 for unlocking the lid 30 of the cassette 24, a suction cup 48 for attracting and removing the stimulable phosphor panel P from the cassette 24, and a pair of nip rollers 50 for gripping and feeding the stimulable phosphor panel P, which has been removed from the cassette 24, by the suction cup 48.

A plurality of feed rollers 52a through 52g and a plurality of guide plates 54a through 54f make up a curved feed path 56 extending from the nip rollers 50. The curved feed path 56 includes a portion disposed between the feed rollers 52c and 52d, which serves as a transverse shifter for shifting the stimulable phosphor panel P in a direction transverse to the feed direction, along the curved feed path 56. The curved feed path 56 extends downwardly from the cassette loader 38, where it lies substantially horizontally at a lowermost portion, and then extends upwardly.

An erasing unit 60 (eraser) for erasing residual radiation image information from the stimulable phosphor panel P, after desired radiation image information has been read therefrom, is disposed between the nip rollers 50 and the feed rollers 52a. The erasing unit 60 comprises a plurality of erasing light sources 62, comprising respective cold cathode-ray tubes for emitting erasing light.

A platen roller 64 is disposed between the feed rollers 52d, 52e located in the lowermost portion of the curved feed path 56. A scanning unit 66 (reader) for reading radiation image information recorded in the stimulable phosphor panel P is disposed above the platen roller 64.

The scanning unit 66 comprises a stimulator 68 for emitting a laser beam LB as stimulating light, whereby the stimulable phosphor panel P is scanned by the laser beam LB in a direction perpendicular to the feed direction. The scanning unit 66 further includes a light collecting guide 70 for collecting stimulated light representative of the radiation image information, which is emitted from the stimulable phosphor panel P when stimulated by the laser beam LB, and a photomultiplier 72 for converting the stimulated light collected by the light collecting guide 70 into an electric signal. A light collecting mirror 74 for enabling the stimulated light to be collected more efficiently is disposed near a lower end of the light collecting guide 70.

The cassette loader 38 also includes an expandable shield cover 76 disposed on an upper surface of the casing 36 between the X-ray source 16 and a portion of the cassette 24 that is exposed outside of the casing 36. When the expandable shield cover 76 is spread, it shields the cassette 24 from X-ray radiation 20 emitted by the X-ray source 16. The shield cover 76 is collapsible when not in use.

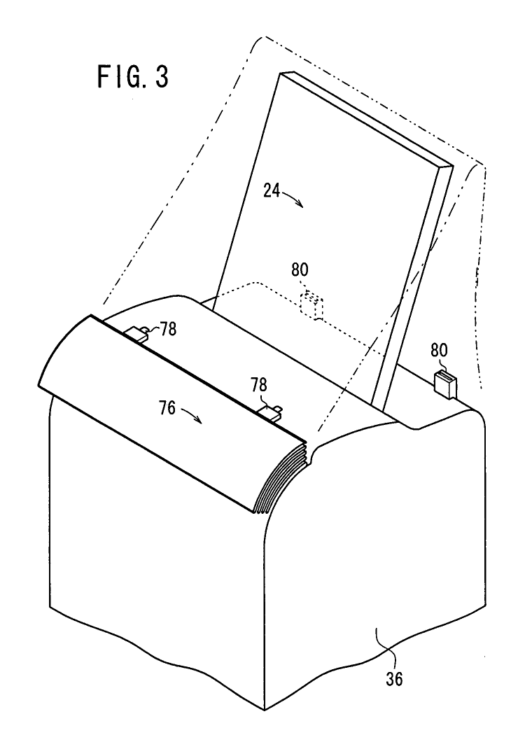

As shown in FIGS. 2 and 3, the cover 76 has one end thereof fixed to an end of the upper portion of the casing 36, and is collapsed in the form of a folded window shade when not in use. The cover 76 comprises a curtain of lead or another metal capable of preventing X-ray radiation 20 from being applied to the cassette 24.

Engaging fingers 78 are connected to the other end of the cover 76. When the cover 76 is expanded to cover the cassette 24, the engaging fingers 78 can be secured to respective fixing members 80, which are mounted at the other end on the upper portion of the casing 36. A sensor 82 is disposed in the casing 36 near the fixing members 80, for detecting electrically when the engaging fingers 78 have been fixed to the respective fixing members 80.

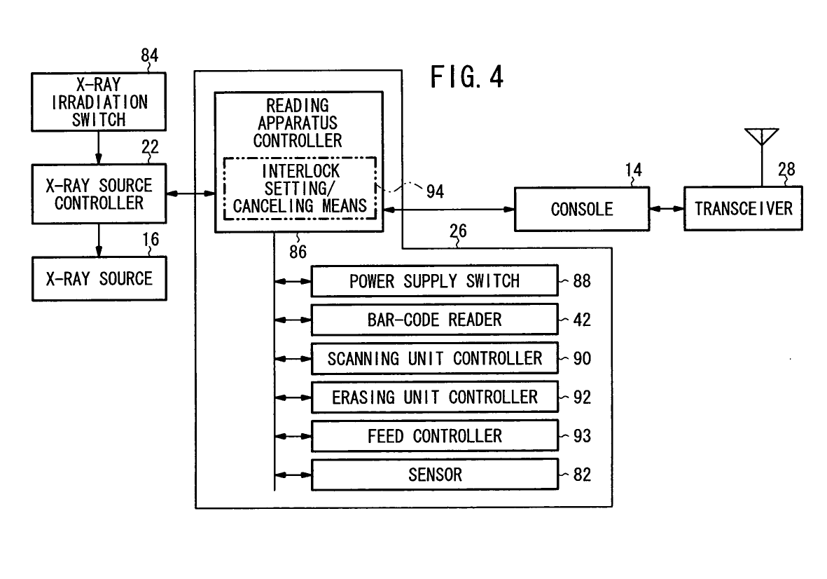

FIG. 4 shows in block form a control system of the radiation image forming system 10. An X-ray irradiation switch 84 is connected to the X-ray source controller 22, which is operable by an operator to energize the X-ray source 16 so as to apply X-ray radiation 20 to the subject 18.

The reading apparatus 26 comprises a reading apparatus controller 86, to which there are connected a power supply switch 88 of the reading apparatus 26, a bar-code reader 42, a scanning unit controller 90 for controlling the scanning unit 66, an erasing unit controller 92 for controlling the erasing unit 60, a feed controller 93 for controlling the curved feed path 56 in order to feed the stimulable phosphor panel P, and a sensor 82.

The reading apparatus controller 86 includes an interlock setting/canceling means 94 for setting or canceling an interlock of the X-ray source 16 based on a signal from the bar-code reader 42 representing information indicative of whether there is a cassette 24 or not, and a signal from the sensor 82 representing information indicative of whether the cover 76 is expanded or not.

Operations of the radiation image forming system 10 thus constructed shall be described below.

First, an operator moves the radiation image forming system 10 on the carriage 12 to a location where the subject 18 is to be imaged, e.g., the patient's room occupied by the subject 18, and then turns on the power supplies of the console 14 and the reading apparatus 26, which are included in the radiation image forming system 10.

Then, the operator operates the console 14 to enter image capturing information, including the name of the subject 18, a region to be imaged, an image capturing process, etc. Alternatively, the image capturing information may be acquired from the external device through the transceiver 28. In addition, the console 14 is operated to select the cassette 24 to be used for recording radiation image information of the subject 18, and to read the bar code on the cassette 24 in order to acquire ID information of the cassette 24. The selected cassette 24 stores a stimulable phosphor panel P therein, whose size and sensitivity depends on the region to be imaged. When the imaging information and the ID information of the cassette 24 have been established, and the preparatory process for the image capturing operation has been completed, the console 14 transmits the imaging information and the ID information of the cassette 24 to the reading apparatus controller 86 of the reading apparatus 26.

After the operator has set the cassette 24 at a position below the subject 18 and moves the arm 29 so as to set the X-ray source 16 at a position over the subject 18, the operator operates the X-ray irradiation switch 84. The X-ray source controller 22 energizes the X-ray source 16 to emit and apply X-ray radiation 20 to the subject 18. The X-ray radiation 20, having passed through the subject 18, is applied to the stimulable phosphor panel P stored in the cassette 24, thereby recording radiation image information of the subject 18 in the stimulable phosphor panel P.

The operator then places the cassette 24, storing the stimulable phosphor panel P with the radiation image information recorded therein, into the reading apparatus 26, and spreads the cover 76 from the collapsed position indicated by the solid lines in FIGS. 2 and 3. After the operator has secured the engaging fingers 78 in the fixing members 80 on the casing 36, as indicated by the broken lines in FIGS. 2 and 3, the reading apparatus 26 reads the radiation image information from the stimulable phosphor panel P, and thereafter erases any residual radiation image information from the stimulable phosphor panel P.

Specifically, when the cassette 24 is loaded into the cassette loader 38 with the lid 30 positioned downward, the bar-code reader 42 reads the bar code on the cassette 24 in order to acquire ID information of the cassette 24. Then, the unlocking mechanism 46 unlocks and opens the lid 30. Thereafter, the suction cup 48 attracts and removes the stimulable phosphor panel P from the cassette 24, and supplies the stimulable phosphor panel P to the nip rollers 50. The nip rollers 50 grip and feed the stimulable phosphor panel P to the curved feed path 56. The feed rollers 52a through 52g then feed the stimulable phosphor panel P along the curved feed path 56.

While the stimulable phosphor panel P is fed in an auxiliary scanning direction between the feed rollers 52d and 52e, the laser beam LB emitted from the stimulator 68 scans the stimulable phosphor panel P in a main scanning direction in order to read radiation image information from the stimulable phosphor panel P.

Specifically, when the laser beam LB emitted from the stimulator 68 is applied to the stimulable phosphor panel P, the stimulable phosphor panel P emits stimulated light representative of the recorded radiation image information. The stimulated light is guided by the light collecting guide 70 to the photomultiplier 72, which converts the stimulated light into electric signals representing the radiation image information. The radiation image information represented by the electric signals, and the ID information of the cassette 24, are stored in a memory (not shown) or sent through the console 14 to the transceiver 28, which sends the radiation image information and the ID information to an indoor transceiver (not shown).

The stimulable phosphor panel P, from which recorded radiation image information has been read, is fed to the guide plate 54f, and then is fed back to the cassette loader 38 through the region below the scanning unit 66. The stimulable phosphor panel P, as it is returned to the cassette loader 38, is irradiated with erasing light emitted from the erasing light sources 62 of the erasing unit 60, which is disposed between the nip rollers 50 and the feed rollers 52a. In this manner, residual radiation image information is erased from the stimulable phosphor panel P.

After residual radiation image information has been erased from the stimulable phosphor panel P, the stimulable phosphor panel P is returned into the cassette 24 by the nip rollers 50 and the suction cup 48. Then, the lid 30 is closed, and the stimulable phosphor panel P stored within the cassette 24 can be used for recording other additional radiation image information.

According to the first embodiment, when the cassette 24 is loaded in the cassette loader 38, a bar code on the cassette is read by the bar-code reader 42. Thus, information indicating that the cassette 24 has been loaded into the cassette loader 38 is sent to the interlock setting/canceling means 94.

If the cover 76 is in a collapsed or stored state at this time, the sensor 82 is not activated. Therefore, the interlock setting/canceling means 94 sets an interlock for the X-ray source 16, thereby inhibiting the X-ray source 16 from emitting X-ray radiation 20.

The operator then expands the cover 76 over the cassette 24 and secures the engaging fingers 78 in the fixing members 80, whereupon the sensor 82 sends an interlock canceling signal to the interlock setting/canceling means 94. The interlock for the X-ray source 16 is canceled, and the X-ray source controller 22 controls the X-ray source 16 so as to emit and apply X-ray radiation 20 through the subject 18 to the stimulable phosphor panel P stored in the cassette 24. Radiation image information of the subject 18 thus is recorded in the stimulable phosphor panel P.

While other radiation image information of the subject 18 is being recorded in the stimulable phosphor panel P, as described above, the radiation image information, which is already recorded in the stimulable phosphor panel P stored in the cassette 24 loaded in the reading apparatus 26, is read by the reading apparatus 26.

Since the portion of the cassette 24 that is exposed outside of the reading apparatus 26 is shielded from the X-ray source 16 by the cover 76, the radiation image information recorded in the stimulable phosphor panel P stored in the cassette 24 loaded in the reading apparatus 26 can be read by the reading apparatus 26, while additional radiation image information of the subject 18 is being recorded in the stimulable phosphor panel P by means of X-ray radiation 20 applied from the X-ray source 16 to the subject 18. Accordingly, X-ray radiation image information can be captured and read efficiently with a simple arrangement.

The interlock setting/canceling means 94 cancels the interlock for the X-ray source 16, thereby allowing the X-ray source 16 to be energized, only when the cassette 24 loaded in the reading apparatus 26 is shielded from the X-ray source 16 by the cover 76. Therefore, X-ray radiation emitted from the X-ray source 16 is reliably prevented from being applied to the cassette 24 that is loaded in the reading apparatus 26. The stimulable phosphor panel P, whose recorded radiation image information is read inside the reading apparatus 26, is not irradiated with any X-ray radiation from an external source. Thus, the recorded radiation image information can be read highly reliably from the stimulable phosphor panel P in order to produce a high-quality radiation image.

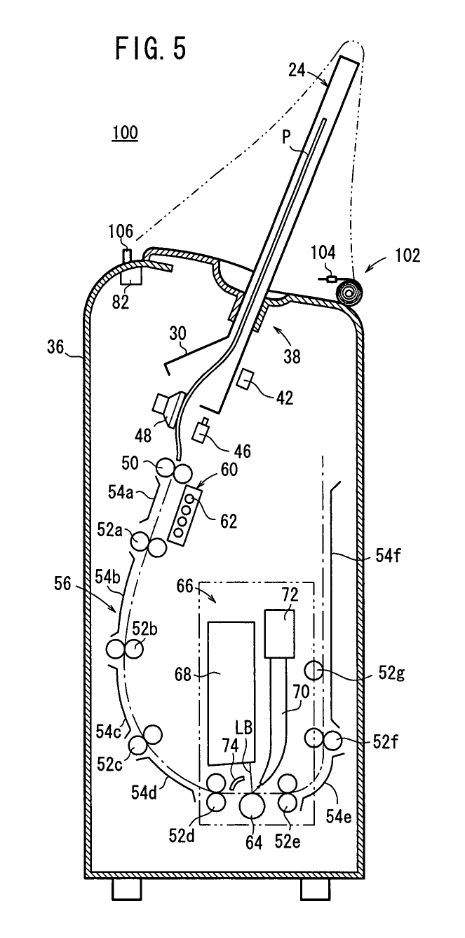

FIG. 5 shows in vertical cross section internal structural details of a reading apparatus 100, according to a second embodiment of the present invention. Those parts of the reading apparatus 100 which are identical to those of the reading apparatus 26 according to the first embodiment are denoted using identical reference characters, and such features shall not be described in detail below.

The reading apparatus 100 has an expandable shield cover 102, which is normally stored in a rolled-up form on a rear end (or front end) of an upper portion of the casing 36. The cover 102 has an engaging finger 104 on a distal end thereof. When the distal end of the cover 102 is pulled from the rolled cover 102, the cover 102 is expanded.

When the cover 102 is expanded, the engaging finger 104 can be fixed to a fixing member 106 mounted on the front end (or rear end) of the upper portion of the casing 36. A sensor 82, disposed inside the casing 36 near the fixing member 106, detects when the engaging finger 104 has been fixed to the fixing member 106, and thus sends a detection signal to the interlock setting/canceling means 94 (see FIG. 4).

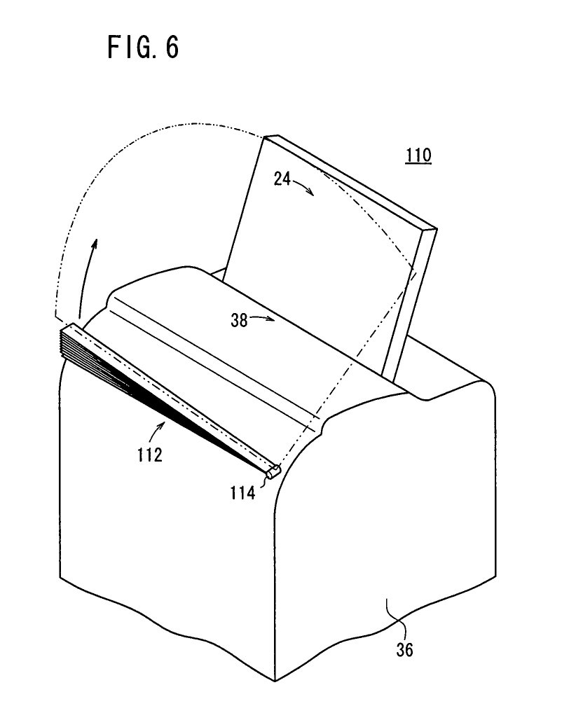

FIG. 6 shows in perspective an upper portion of a reading apparatus 110, according to a third embodiment of the present invention.

The reading apparatus 110 includes an expandable shield cover 112 mounted on the front end of an upper portion of the casing 36. The cover 112 can be expanded in a fanned out form about a pivot 114. When the cover 112 is expanded, as indicated by the two-dot-and-dash line, the cover 112 covers one side of the cassette 24 in order to prevent the cassette 24 from being irradiated with X-ray radiation 20.

A sensor, not shown, is provided for detecting when the cover 112 has been expanded in a fanned out form. When the sensor detects that the cover 112 has been expanded and fanned out, the sensor sends a detection signal to the interlock setting/canceling means 94.

According to the second and third embodiments, after the cassette 24 has been loaded into the cassette loader 38, the covers 102, 112 are expanded in order to cover the cassette 24, whereupon the interlock for the X-ray source 16 is canceled. Therefore, the process of capturing X-ray radiation image information, and the process of reading recorded radiation image information, can simultaneously be performed, in a similar manner to the first embodiment.

In the first and second embodiments, the covers 76, 102 are expanded to cover opposite surfaces and an upper portion of the cassette 24. However, the covers 76, 102 may be expanded so as to provide a shield at least between the cassette 24 and the X-ray source 16, or the covers 76, 102 may be expanded to cover the entire surface of the cassette 24.

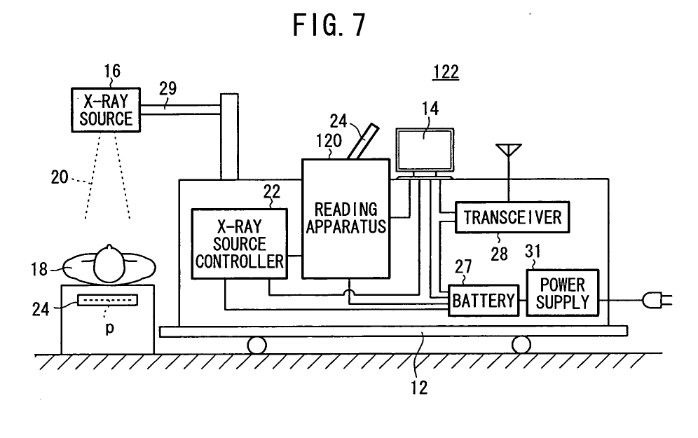

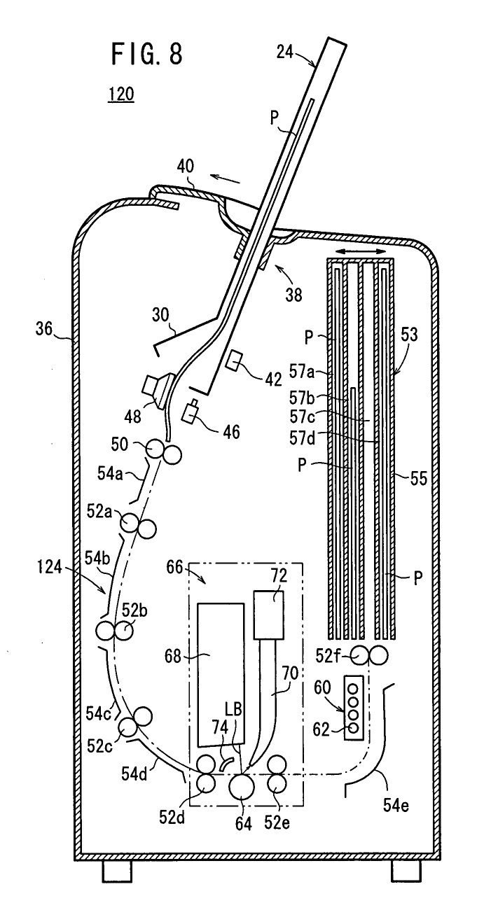

FIG. 7 shows in block form a radiation image forming system 122 incorporating a reading apparatus 120, according to a fourth embodiment of the present invention. The reading apparatus 120 is constructed as shown in FIG. 8. Those parts of the reading apparatus 120 that are identical to the reading apparatus 26 according to the first embodiment are denoted using identical reference characters, and such features shall not be described in detail below.

The reading apparatus 120 includes a curved feed path 124 disposed in the casing 36 for feeding the stimulable phosphor panel P. The curved feed path 124 comprises feed rollers 52a through 52f, and guide plates 54a through 54e.

The curved feed path 124 includes an upwardly extending end portion disposed below a stacker 53 (stacking unit), in which multiple stimulable phosphor panels P are stacked. The stacker 53 includes a case 55 made of a radiation blocking material, and which is divided into a plurality of panel storage bins 57a through 57d for storing respective stimulable phosphor panels P therein. The curved feed path 124 and the stacker 53, which is disposed at an end of the curved feed path 124 for stacking a plurality of stimulable phosphor panels P therein, enable the reading apparatus 120 to be small in size.

Since the case 55 of the stacker 53 is made of a radiation-impermeable material, the casing 36 of the reading apparatus 120 need not entirely be made of a radiation-impermeable material. That is, the casing 36 may only partially be made of a radiation-impermeable material. Consequently, the reading apparatus 120 can be reduced in both weight and cost.

The erasing unit 60, for erasing residual radiation image information from the stimulable phosphor panel P, is disposed between the feed rollers 52e, 52f immediately prior to the stacker 53.

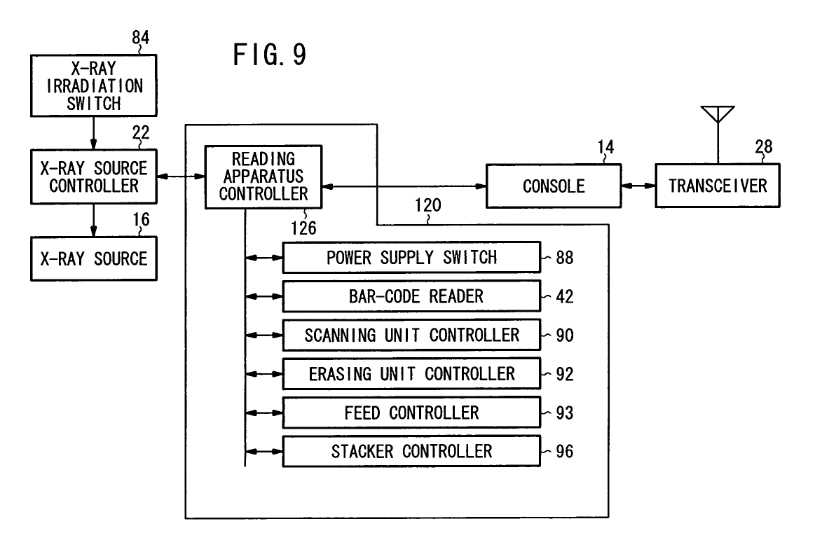

FIG. 9 shows in block form a control system for the radiation image forming system 122. The reading apparatus 120 has a reading apparatus controller 126 having connected thereto a power supply switch 88 for the reading apparatus 120, a bar-code reader 42 for reading a bar code on the cassette 24, a scanning unit controller 90 for controlling the scanning unit 66, an erasing unit controller 92 for controlling the erasing unit 60, a feed controller 93 for controlling the curved feed path 56 in order to feed the stimulable phosphor panel P, and a stacker controller 96 for transporting the stacker 53 in horizontal directions, as indicated by the arrow in FIG. 8, so as to bring one of the panel storage bins 57a through 57d into alignment with the end of the curved feed path 124.

The radiation image forming system 122 operates in the same manner as the radiation image forming system 10 according to the first embodiment, in order to apply X-ray radiation 20 from the X-ray source 16 to the subject 18, and to record radiation image information of the subject 18 in the stimulable phosphor panel P.

In the reading apparatus 120, while X-ray radiation 20 is being applied to the subject 18, other stimulable phosphor panels P, which are not currently being used to record radiation image information therein, are kept in a waiting mode within the stacker 53 and are not discharged into the cassette 24 loaded in the cassette loader 38. Accordingly, stimulable phosphor panels P, which are in a waiting mode, are prevented from suffering sensitivity reduction due to being irradiated with X-ray radiation X.

After recording of the radiation image information in the stimulable phosphor panel P has finished, the cassette 24 storing the stimulable phosphor panel P therein is loaded into the reading apparatus 120, whereupon the stimulable phosphor panel P is removed from the cassette 24 and fed through the curved feed path 124 to a position beneath the scanning unit 66 for reading the recorded radiation image information.

The stimulable phosphor panel P, from which radiation image information has been read, is then transported to the erasing unit 60 disposed between the feed rollers 52e and 52f, which erases any residual radiation image information from the stimulable phosphor panel P in a primary mode. Then, the stacker 53 is shifted so as to bring an empty one of the panel storage bins 50a through 57d into alignment with the curved feed path 124, and the stimulable phosphor panel P is delivered into the empty panel storage bin by the feed rollers 50f.

Specifically, the stacker controller 96 for controlling the stacker 53 acquires size and sensitivity information of the stimulable phosphor panel P, based on the ID information of the stimulable phosphor panel P read by the bar-code reader 42. The stacker controller 96 also acquires empty panel storage bin information concerning the panel storage bins 50a through 57d of the stacker 53 from the reading apparatus controller 126. Based on the size information and sensitivity information of the stimulable phosphor panel P, the stacker controller 96 moves the stacker 53 in directions indicated by the arrow in FIG. 8, so as to position an empty one of the panel storage bins 50a through 57d above the feed rollers 52f. Then, the feed rollers 52f feed the stimulable phosphor panel P into an empty one of the panel storage bins 50a through 57d.

If plural cassettes 24 are available, storing respective stimulable phosphor panels P therein, then radiation image information is recorded successively in the stimulable phosphor panels P, which are stored in the cassettes 24. Thereafter, the cassettes 24 are successively loaded into the reading apparatus 120 in order to successively read the recorded radiation image information from the stimulable phosphor panels P. Specifically, after an empty cassette 24 loaded in the cassette loader 38 has been removed, another cassette 24, storing a stimulable phosphor panel P therein, is loaded into the cassette loader 38. The stimulable phosphor panel P is taken out of the loaded cassette 24 and fed to the scanning unit 66 in order to read the recorded radiation image information therefrom, and then the stimulable phosphor panel P is fed to the erasing unit 60 to erase any residual radiation image information therefrom. Thereafter, the stimulable phosphor panel P is stacked in the stacker 53. This process is repeated until all of the stimulable phosphor panels P have been stacked in the stacker 53.

When the X-ray source controller 22 requests one of the stimulable phosphor panels P that are stacked in the stacker 53 for recording radiation image information, the reading apparatus controller 126 initially confirms whether there is an empty cassette 24 loaded in the cassette loader 38 or not. If an empty cassette 24 is not loaded in the cassette loader 38, then the operator loads an empty cassette 24 into the cassette loader 38.

Then, the stacker controller 96 moves the stacker 53 in directions indicated by the arrow in FIG. 8, based on the image capturing information sent from the console 14 concerning the region to be imaged, until one of the panel storage bins 57a through 57d, which stores a stimulable phosphor panel P having a size and sensitivity based on the image capturing information, is positioned above the feed rollers 52f. The feed rollers 52f remove the stimulable phosphor panel P from the panel storage bin, which is positioned above the feed rollers 52f.

The stimulable phosphor panel P is removed from the stacker 53 and sent to the erasing unit 60, which erases any residual radiation image information that remains within the stimulable phosphor panel P in a secondary mode. The stimulable phosphor panel P is then stored in the empty cassette 24, which is positioned in the cassette loader 38, by the feed rollers 52e through 52a and the nip rollers 50, whereby the stimulable phosphor panel P can subsequently be used to record radiation image information.

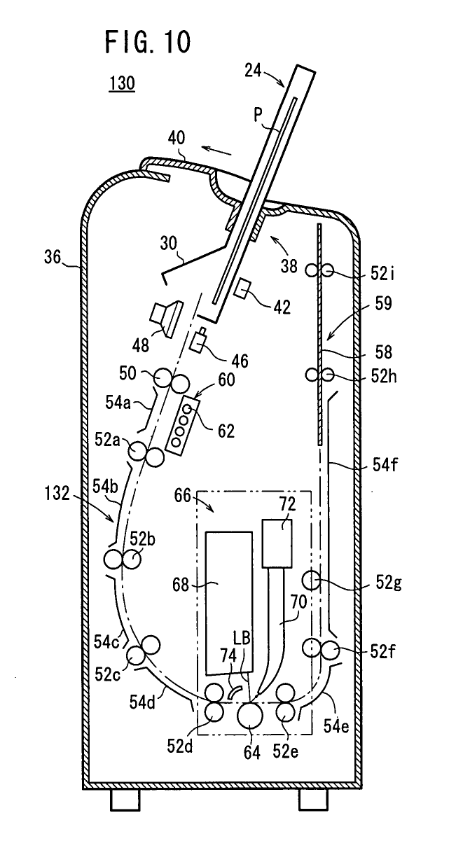

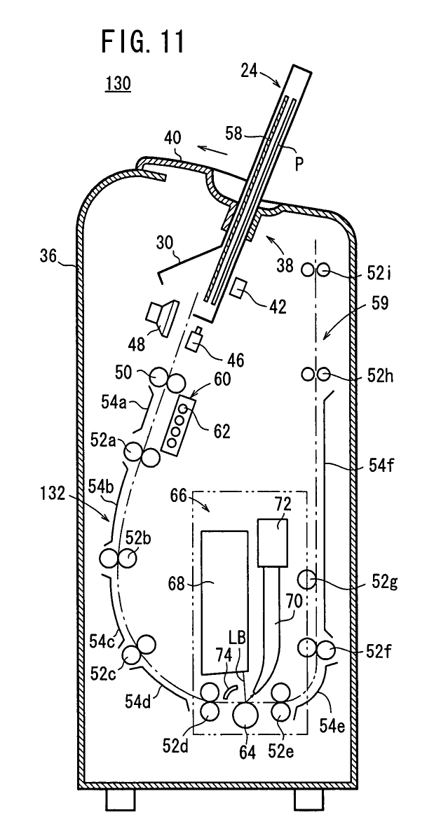

FIGS. 10 and 11 show a reading apparatus 130 according to a fifth embodiment of the present invention. The reading apparatus 130 may be substituted for the reading apparatus 120 used in the radiation image forming system 122 shown in FIG. 7. Those parts of the reading apparatus 130 which are identical to those of the reading apparatus 120 according to the fourth embodiment are denoted using identical reference characters, and detailed descriptions of such elements shall not be provided below.

As shown in FIGS. 10 and 11, the reading apparatus 130 includes a curved feed path 132 (feed means) therein for feeding the stimulable phosphor panel P. The curved feed path 132 is made up of feed rollers 52a through 52i and guide plates 54a through 54f. The curved feed path 132 includes a portion, referred to as a rear feed path, which extends substantially vertically upward from a position near the scanning unit 66. A shutter storage unit 59, for storing a shutter 58 to be placed inside the cassette 24, is disposed above the rear feed path. The shutter 58 is substantially the same size as the stimulable phosphor panel P stored in the cassette 24, and is made of a material capable of blocking X-ray radiation 20.

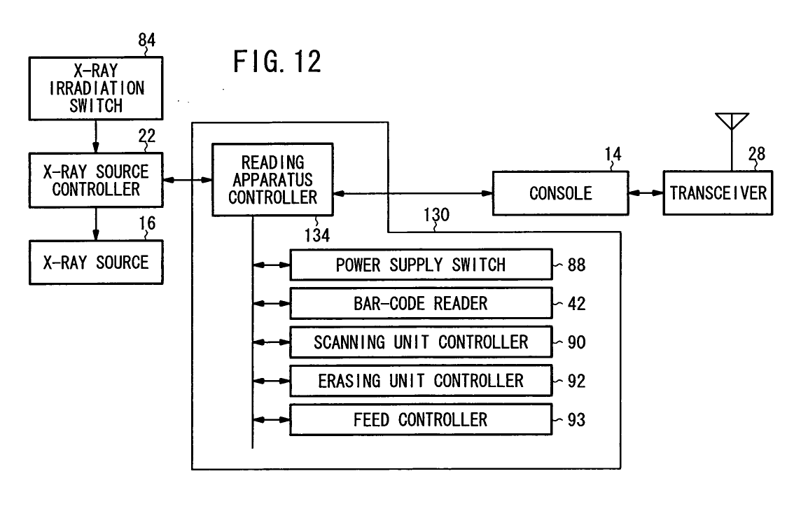

FIG. 12 shows in block form a control system of the radiation image forming system, incorporating therein the reading apparatus 130. As shown in FIG. 12, the reading apparatus 130 includes a reading apparatus controller 134, which serves as an image capture permission signal output means. Other details of the control system shown in FIG. 12 are identical to the control system pertaining to the reading apparatus 120 shown in FIG. 9, except for the stacker controller 96.

The reading apparatus 130 operates as follows: When the cassette 24 is loaded into the cassette loader 38 and the lid 30 is opened, the feed controller 93 actuates the feed rollers 52a through 52i of the curved feed path 132 in order to feed the shutter 58 (see FIG. 10) that is stored in the shutter storage unit 59 along the curved feed path 132, and into the cassette 24 storing the stimulable phosphor panel P (FIG. 11).

The stimulable phosphor panel P, which is stored in the cassette 24, and wherein an upper portion of the cassette 24 projects outside of the reading apparatus 130, is shielded by the shutter 58 that is inserted between the inner surface of the cassette 24 and the surface of the stimulable phosphor panel P. Specifically, the stimulable phosphor panel P is shielded from stray X-ray radiation 20 that may leak from the X-ray source 16, or from X-ray radiation that may be scattered and applied to the cassette 24.

A control may be provided so as to begin inserting the shutter 58 into the cassette 24 once the X-ray source controller 22 has supplied an image capture preparation completion signal to the reading apparatus controller 134. When controlled in this manner, unwanted operations can be avoided, assuming the shutter 58 does not need to be inserted into the cassette 24.

Once the shutter 58 has been inserted into the cassette 24, the reading apparatus controller 134 outputs an image capture permission signal to the X-ray source controller 22. In response to an irradiation start signal from the X-ray irradiation switch 84, the X-ray source controller 22 begins applying X-ray radiation 20 from the X-ray source 16 to the subject 18.

Even if a portion of the X-ray radiation 20 emitted from the X-ray source 16 leaks toward the reading apparatus 26, or is scattered and applied to the cassette 24, since the shutter 58 is inserted in the cassette 24 and shields the stimulable phosphor panel P from the X-ray radiation 20, the radiation image information recorded in the stimulable phosphor panel P is protected against damage from stray X-ray radiation.

In the reading apparatus 130, the stimulable phosphor panel P is removed from the cassette 24 while the shutter 58 remains inserted therein. Then, the stimulable phosphor panel P is fed down the curved feed path 132 to a position below the scanning unit 66, where the radiation image information recorded in the stimulable phosphor panel P is read.

After the radiation image information has been read from the stimulable phosphor panel P, the stimulable phosphor panel P is fed to the guide plate 54f, and then, the stimulable phosphor panel P is fed back to the cassette loader 38 while passing through the position below the scanning unit 66. Any residual radiation image information remaining in the stimulable phosphor panel P is erased by the erasing unit 60, which is disposed between the nip rollers 50 and the feed rollers 52a.

The stimulable phosphor panel P, from which residual radiation image information has been erased, is restored inside the cassette 24 with the shutter 58 inserted therein. At this time, if X-ray radiation 20 from the X-ray source 16 is being applied to the subject 18 in order to record radiation image information from the subject 18, then the stimulable phosphor panel P inside the cassette 24 remains unremoved while it is stored in the cassette 24. The stimulable phosphor panel P inside the cassette 24 is protected from exposure to X-ray radiation 20 by means of the shutter 58, which is inserted in the cassette 24.

When the X-ray source controller 22 outputs an image capture completion signal to the reading apparatus controller 134, the suction cup 48 attracts and removes the shutter 58 from the cassette 24. Then, the feed controller 93 actuates the feed rollers 52a through 52i to feed the shutter 58 to the shutter storage unit 59, which stores the shutter 58 therein (FIG. 10).

Thereafter, the lid 30 is closed, whereupon the cassette 24 with the stimulable phosphor panel P therein can be used to record subsequent radiation image information.

The present invention is not limited to the above embodiments. The embodiments may be changed or modified within the scope of the invention.

For example, the cassette 24 may store a back scattering prevention plate, made of a material such as lead or the like, for preventing back scattering of X-ray radiation, wherein the back scattering prevention plate is disposed on an inner surface of the stimulable phosphor panel P remote from the recording surface thereof. Since the back scattering prevention plate blocks X-ray radiation 20 that tends to enter the cassette 24 from outside, the shutter 58 may be inserted on the recording surface of the stimulable phosphor panel P. Alternatively, two shutters 58 may be inserted in the cassette 24, one on each side of the stimulable phosphor panel P. Each of the reading apparatus 26, 120, 130 may employ other types of radiation conversion panels, comprising semiconductor devices, for example, rather than the stimulable phosphor panel P.

Although certain preferred embodiments of the present invention have been shown and described in detail, it should be understood that various changes and modifications may be made to the embodiments without departing from the scope of the invention as set forth in the appended claims.

What is claimed is:

1. A radiation image reading apparatus for reading radiation image information of a subject from a radiation conversion panel, which has radiation image information recorded therein, said radiation image reading apparatus comprising:
a cassette loader for being removably loaded with a radiation cassette storing said radiation conversion panel therein, said radiation cassette having at least a portion exposed outside of said radiation image reading apparatus; and
said cassette loader including a shield cover disposed at least between a radiation source and the exposed portion of said radiation cassette, for shielding said radiation cassette from said radiation source, said shield cover being storable on said radiation image reading apparatus.

2. A radiation image reading apparatus according to claim 1, further comprising:
interlock setting/canceling means for setting an interlock between said shield cover and said radiation source, and canceling said interlock when said shield cover shields said radiation cassette, thereby allowing said radiation source to apply radiation.

3. A radiation image reading apparatus according to claim 1, wherein said radiation image reading apparatus and said radiation source are mounted on a transportation carriage.

4. A radiation image reading apparatus for reading radiation image information of a subject from a radiation conversion panel, which has radiation image information recorded therein, said radiation image reading apparatus comprising:
a cassette loader for being removably loaded with a radiation cassette storing said radiation conversion panel therein;
a reader for reading radiation image information recorded in said radiation conversion panel; and
a stacking unit for stacking said radiation conversion panel therein,
wherein said stacking unit includes a member made of a radiation blocking material for shielding said radiation conversion panel from a radiation source.

5. A radiation image reading apparatus according to claim 4, wherein said radiation image reading apparatus and a radiation image capturing apparatus for applying radiation to said subject are mounted on a movable carriage.

6. A radiation image reading apparatus according to claim 4, wherein said stacking unit is capable of stacking a plurality of said radiation conversion panels therein.

7. A radiation image reading apparatus according to claim 6, wherein said stacking unit is capable of stacking different types of said radiation conversion panels, and of selecting and supplying one type of said radiation conversion panels at a time to said radiation cassette.

8. A radiation image reading apparatus according to claim 1, further comprising:
an eraser for erasing residual radiation image information remaining in said radiation conversion panel after the radiation image information recorded therein has been read.

9. A method of controlling a radiation image reading apparatus for reading radiation image information of a subject from a radiation conversion panel, which has radiation image information recorded therein, said method comprising the steps of:
removing said radiation conversion panel from a radiation cassette loaded in said radiation image reading apparatus;
reading the radiation image information from said radiation conversion panel;
thereafter, stacking said radiation conversion panel in a stacking unit disposed in said radiation image reading apparatus, said stacking unit including a member made of a radiation blocking material;
removing said radiation conversion panel from said stacking unit in response to a request from a radiation image capturing apparatus; and
storing said radiation conversion panel in said radiation cassette so that said radiation conversion panel can be supplied to said radiation image capturing apparatus.

10. A method according to claim 9, further comprising the step of:
erasing residual radiation image information remaining in said radiation conversion panel when the radiation conversion panel is stacked in said stacking unit.

11. A method according to claim 9, further comprising the step of:
erasing residual radiation image information remaining in said radiation conversion panel when the radiation conversion panel is removed from said stacking unit and stored in said radiation cassette.

12. A radiation image reading apparatus for reading radiation image information of a subject from a radiation conversion panel, which has radiation image information recorded therein, said radiation image reading apparatus comprising:
a cassette loader for being removably loaded with a radiation cassette storing said radiation conversion panel therein;
a reader for reading the radiation image information recorded in said radiation conversion panel;
a shutter storage unit for storing a shutter to be inserted between an inner surface of said radiation cassette loaded in said cassette loader and a surface of said radiation conversion panel; and
feed means for feeding said shutter between said cassette loader and said shutter storage unit.

13. A radiation image reading apparatus according to claim 12, further comprising:
an eraser for erasing said radiation image information recorded in said radiation conversion panel.

14. A radiation image reading apparatus according to claim 12, further comprising:
image capture permission signal output means for outputting an image capture permission signal to a device positioned outside said radiation image reading apparatus to permit said device to capture said radiation conversion panel, after said shutter has been inserted in said radiation cassette having said radiation conversion panel stored therein.

15. A radiation image reading apparatus according to claim 1, combined with a radiation image capturing apparatus for recording radiation image information in said radiation conversion panel, wherein said radiation image reading apparatus and said radiation image capturing apparatus are mounted together on a transportation chassis.

16. A method of controlling a radiation image reading apparatus for reading radiation image information of a subject from a radiation conversion panel, which has radiation image information recorded therein, said method comprising the steps of:
inserting a shutter between an inner surface of a radiation cassette and a surface of said radiation conversion panel, when said radiation cassette having said radiation conversion panel stored therein is loaded; and
thereafter, permitting another radiation conversion panel to be captured in order to record radiation image information therein.
